(19) United States
(12) Patent Application Publication
(10) Pub. No.: US 2004/0160057 A1
(43) Pub. Date: Aug. 19, 2004

(54) Base tee connection

(75) Inventor: Dalton B. Barnoff, Senneville (CA)

Correspondence Address: OGILVY RENAULT, 1981 MCGILL COLLEGE AVENUE, SUITE 1600, MONTREAL, QC, H3A2Y3, CA

(73) Assignee: Trans Continental Equipment Ltd., Montreal (CA)

(21) Appl. No.: 10/366,512

(22) Filed: Feb. 14, 2003

(51) Int. Cl. F16L 51/00; F16L 39/00

(52) U.S. Cl. 285/133.11

(57) ABSTRACT

A base Tee connector for connecting, for example, an exhaust pipe to a chimney liner, includes a section of cylindrical pipe made of sheet metal. The base Tee connector includes an open top end adapted for connection with the chimney liner, and an open bottom. A portion of the sheet metal of the cylindrical pipe is deformed and thereby defines a flat open side end adapted for connection with an exhaust pipe. The flat open side end defines a plane substantially tangential to the section of the cylindrical pipe such that a horizontal section of a conventional base Tee connector is significantly shortened while the flat open side end feature of the conventional base Tee connector is retained. Thus, the base Tee connector of the present invention can pass relatively easily through a chimney passage, and it is also relatively easy to connect with an exhaust pipe within a limited space.

### FIELD OF THE INVENTION

The present invention relates to a three-way pipe joint connection, and more particularly to a base Tee connector used in the connection of an exhaust pipe with a chimney liner.

### BACKGROUND OF THE INVENTION

It is well known in the prior art, as is illustrated in FIGS. 1-4, to use a base Tee connector which is a conventional sheet metal T-shaped three-way pipe joint 20 as shown in FIGS. 1-3, to connect an exhaust pipe 22 with a chimney liner 24. Usually a relatively large hole 26 is made in the wall of the chimney to allow for the installation of the base Tee connector. In order to reduce the size of the hole 26 and thereby reduce repair labour and cost, the base Tee connector 20 is first connected, for example to a flexible chimney liner 24. A rope is usually attached to the base Tee connector, and the chimney liner 24 with the attached base Tee connector 20 is then lowered into the chimney 28 from the top thereof. The rope attached to the base Tee connector 20 is suspended down the chimney 28 and can be manipulated through the opening 26 of the chimney wall to facilitate the base Tee connector positioning operation. When the base Tee connector 20 is in place and accessible through the opening 26, the exhaust pipe 22 is moved to pass through the opening 26 and be connected to the base Tee connector 20.

In the prior art, efforts have been made to improve the efficiency of the base Tee connector installation operation. One problem relating to conventional base Tee connector installation operations is the relatively limited space in which the operation the operation is performed to secure the connection of the exhaust pipe 22 to the base Tee connector 20 within the chimney 28. Various locking devices have been developed for a quick, easy and secure attachment of the exhaust pipe 22 to the base Tee connector 20. One example of these improved locking devices is a pin and bayonet slot engaging device, as indicated by numerals 30 and 32, which is described in the Applicant's U.S. patent application Ser. No. 10/073,169, filed on Feb. 13, 2002. Another problem relating to base Tee connector installation lies in that the conventional base Tee connector 20 has a horizontal section 33 projecting laterally from the vertical section 34 which results in difficulties when passing the base Tee connector 20 through the chimney 28, into its position. The projecting horizontal section 33 takes up additional room from the already limited space within the passage of the chimney 28 when the base Tee connector 20 passes through the chimney 28. Further difficulties will occur when the chimney passage is not straight. Therefore, the horizontal section 33 of prior art base Tee connectors is usually relatively short. Some prior art base Tee connectors 36 (see FIG. 4) have a separable horizontal section (not shown) and the separated horizontal section will be connected to the horizontal opening 38 of the base Tee connector 36 only after the base Tee connector 36 without its horizontal section is inserted through the chimney 28 to its position. Nevertheless, in this case an outwardly extending lip 40 around the horizontal opening 38 is provided for a secure connection to the separable horizontal section. This outwardly extending lip 40 may be damaged by contact with the chimney wall during the passage through the limited chimney passage. Furthermore, the prior art horizontal opening 38 is not defined in a plane and therefore the horizontal section must be modified at one end with a pair of pointed snout portions in order to match the shape of the horizontal opening 38.

Therefore, there is a need for an alternative configuration of the base Tee connector which addresses the problems identified above.

### SUMMARY OF THE INVENTION

One object of the present invention is to provide a base Tee connector which can pass relatively easily through a chimney passage for connecting an exhaust pipe to a chimney liner.

Another object of the present invention is to provide a base Tee connector which is relatively convenient for connection of an exhaust pipe to a chimney liner.

In accordance with one aspect of the present invention, a base Tee connector is provided for connecting a substantially horizontal pipe, for example an exhaust pipe, to a substantially vertical pipe, for example a chimney liner. The base Tee connector comprises a hollow body including a substantially cylindrical wall. The substantially cylindrical wall defines an open top end of the connector adapted for connection to the chimney liner. The base Tee connector further includes an open side end adapted for connection with the exhaust pipe. The open side end defines a plane substantially tangential with respect to the substantially cylindrical wall of the main hollow body.

In one embodiment of the present invention the base Tee connector comprises a section of cylindrical pipe made of sheet metal. The section of cylindrical pipe includes an open top end adapted for connection with the chimney, and an open bottom end. A portion of the sheet metal of the cylindrical pipe is deformed and thereby defines a flat open side end adapted for connection with the exhaust pipe. The flat open side end is disposed substantially parallel to and at a distance from a central longitudinal axis of the cylindrical pipe, which is substantially equal to the radius of the cylindrical pipe.

The flat open side end preferably includes an inwardly folded lip extending in a direction substantially perpendicular to the flat open side end, thereby defining an inner periphery of the flat open side end. The inner edge of the inner periphery of the flat open side end is spaced apart from the plane defined by the flat open side end, and is adapted for engaging clips attached to the exhaust pipe when an open end of the exhaust pipe is received in the flat open side end of the connector. Alternatively, the flat open side end could be provided with a variety of locking devices for conveniently securing the exhaust pipe when the exhaust pipe is connected thereto. The base Tee connector also preferably includes a cover for detachably closing the open bottom end.

The base Tee connector of the present invention can pass relatively easily through a chimney passage for conveniently connecting an exhaust pipe to a chimney liner.

Other advantages and features of the present invention will be better understood with reference to preferred embodiments described hereinafter.

### BRIEF DESCRIPTION OF THE DRAWINGS

Having thus generally described the nature of the present invention, reference will now be made to the accompanying drawings, showing by way of illustration the preferred embodiments thereof in contrast to the illustrated prior art, in which:

FIG. 1 is a partial cross-sectional view showing a prior art base Tee connector positioned within a chimney passage to connect an exhaust pipe to a chimney liner;

FIG. 2 is a top plan view of the prior art of FIG. 1 without the exhaust pipe;

FIG. 3 is a perspective view of the prior art base Tee connector used in the illustration of FIG. 1;

FIG. 4 is a perspective view of another prior art base Tee connector having a separable horizontal section that is removed and not shown;

FIG. 5 is an exploded perspective view of a base Tee connector incorporating one embodiment of the present invention;

FIG. 6 is a top plan view of FIG. 5 with broken lines showing a cross-section of a chimney passage;

FIG. 7A-D are side elevational views showing a manufacturing process of a base Tee connector according to another embodiment of the present invention;

FIG. 8 is a side elevational view of an exhaust pipe having clips to lock the exhaust pipe into position when the exhaust pipe is connected to a base Tee connector of the present invention; and

FIG. 9 is a side elevational view of a base Tee connector according to a further embodiment of the present invention showing alternative locking means attached thereto.

### DETAILED DESCRIPTION OF THE PREFERRED EMBODIMENTS

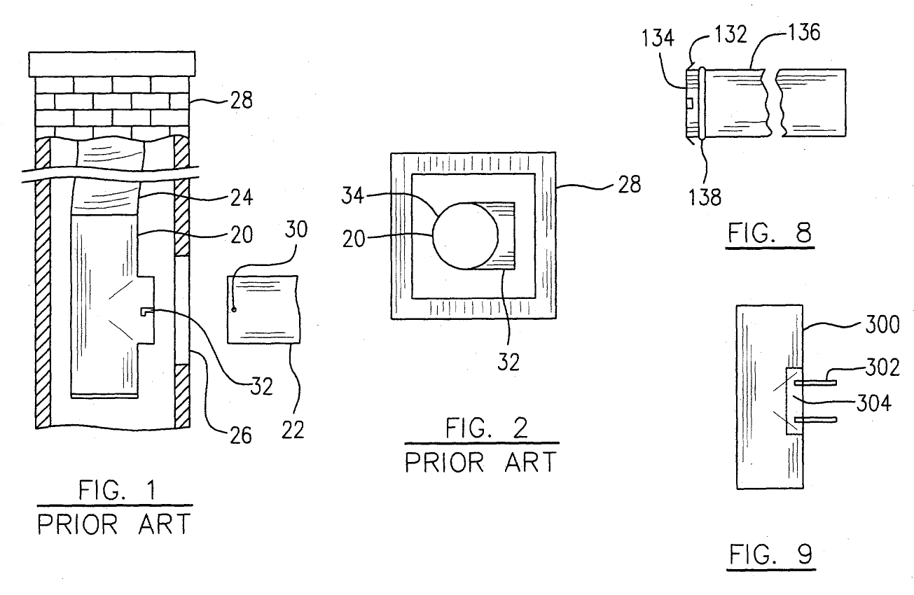

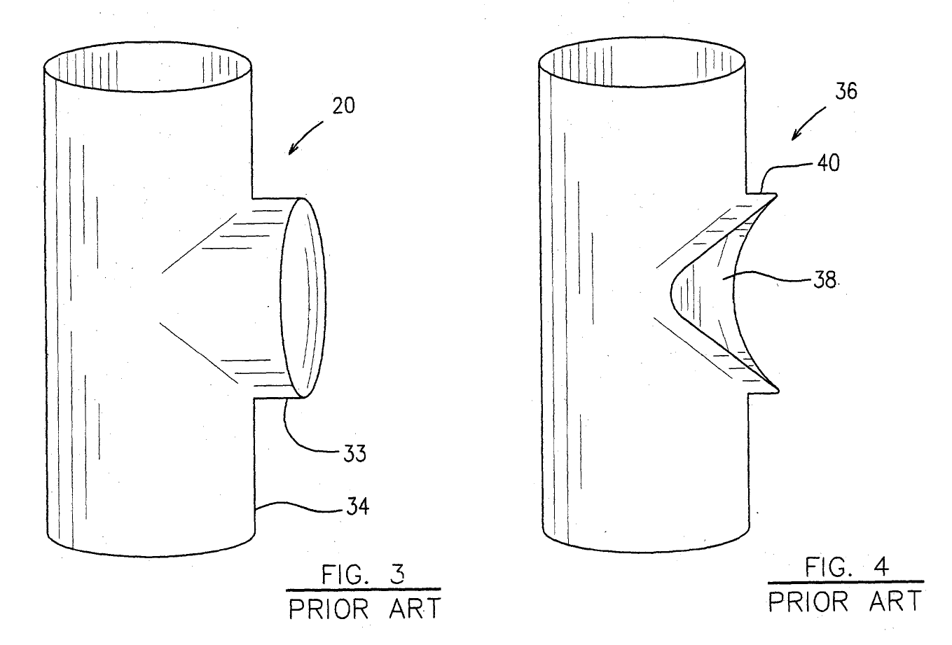

FIGS. 1-4 illustrate the prior art base Tee connectors as described above, in contrast to which the distinct features of the embodiments of the present invention will be described below.

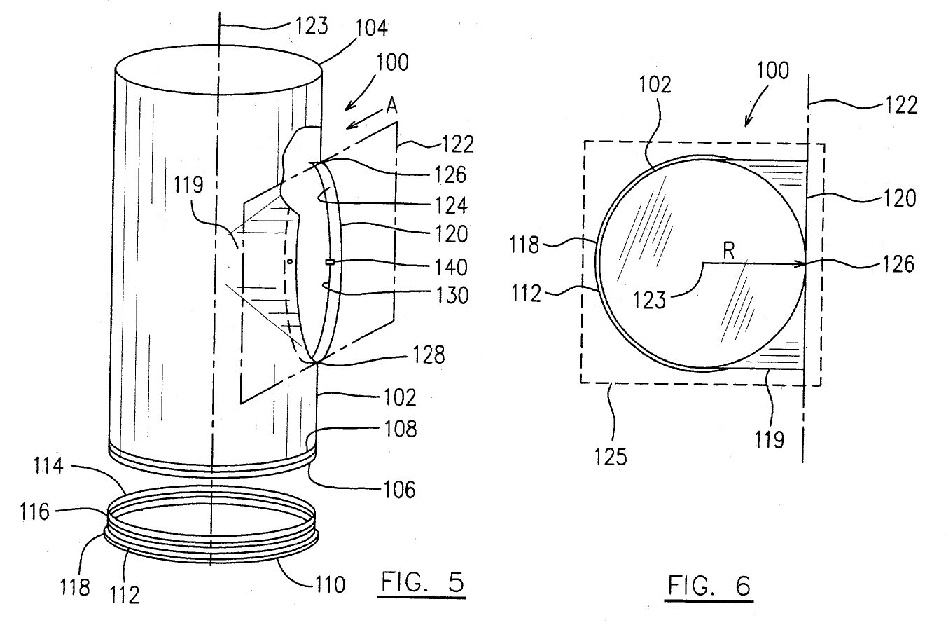

Referring to FIGS. 5 and 6, a base Tee connector according to one preferred embodiment of the present invention, and generally indicated by numeral 100 includes a main hollow body having a substantially cylindrical wall. The main hollow body in this embodiment is a section of a cylindrical pipe 102 made of sheet metal including a top end 104 for connection with a chimney liner, and an open bottom end 106. The bottom end 106 preferably includes inwardly or outwardly projecting annular ridges 108 which are formed by the deformation of the cylindrical wall of sheet metal. A bottom cover 110 is provided for releasably closing the open bottom end 106. The bottom cover 110 includes a round plate 112 of sheet metal with an annular flange 114 extending axially to be snugly received in the open bottom end 106. Complimentary annular ridges 116 are formed on the annular flange 114 for engagement with the annular ridges 108 of the open bottom end 106. The annular flange 114 is integrated with the plate 112 of sheet metal and is bent in a manner to form a folded annular lip 118 to prevent the bottom cover 110 from being over-pushed into the open bottom end 106 of the connector 100.

A middle portion of the cylindrical pipe 102 is deformed and thereby defines a flat open side end 120 adapted for connection with an exhaust pipe. The flat open side end 120 defines a plane 122 which is disposed substantially parallel to and at a distance from the central longitudinal axis 123 of the cylindrical pipe 102. The distance is substantially equal to the radius “R” of the cylindrical pipe 102 and therefore the plane 122 is substantially tangential with respect to the cylindrical pipe 102, as more clearly shown in FIG. 6. Comparing the base Tee connector 100 with the prior art base Tee connector 20 shown in FIG. 3, the advantage of the present invention lies in that the lateral projection length of the horizontal section of the prior art base Tee is significantly reduced to the greatest possible extent while a flat open side end feature is maintained. The broken line 125 in FIG. 6 shows a cross-section of a regular chimney passage. The outline of the base Tee connector 100 in the top plan view of FIG. 6 fits easily into the normal chimney passage 125, which makes it easier to pass the base Tee connector 100 through the chimney passage 125.

An open end of the exhaust pipe can then be fitly slided into the flat open side end 120 of the base tee connector 100. A variety of securing means can be used to lock the open end of the exhaust pipe in this connected position. In order to have a better connection of the exhaust pipe to the flat open side end 120 of the base Tee connector 100, it is preferable to have an annular lip extending inwardly from the flat open side end 120 in a direction substantially perpendicular to the plane 122, thereby defining an inner periphery 124 of the flat open side end 120. A portion of the sheet metal in the area indicated by arrow A in FIG. 5 is cut and removed, in order to show the cross-section of the inner periphery 124 at its highest point. A deformed portion 119 of the sheet metal of the cylindrical pipe 102 in fact forms a part of the horizontal cylindrical section of the base Tee connector 100, therefore a major portion of the inner periphery 124 is superposed on the inner surface of the deformed portion 119 of the sheet metal. Nevertheless, the cylindrical horizontal section formed by the deformed portion 119 of the sheet metal is reduced to a zero length at the uppermost and lowermost points 126, 128, and therefore the inner periphery 124 at those two points extends inwardly from the cylindrical pipe 102 to form a right angle therebetween. Thus, an inner edge 130 of the inner periphery 124 forms a small annular shoulder spaced apart from the flat open side end 120, which can be used to engage clips 132 attached to an open end 134 of an exhaust pipe 136, as shown in FIG. 8. The exhaust pipe 136 is also provided with an annular ridge 138 projecting radially outwardly, such that when the open end 134 of the exhaust pipe 136 is inserted into the flat open side end 120 of the base Tee connector 100, clips 132 will be pressed radially and inwardly by the inner periphery 124 and will then expand radially outwardly to engage the inner edge 130 of the inner periphery 124 upon passing the inner edge 130. The outwardly projecting annular ridge 138 of the exhaust pipe 136 prevents the open end 134 of the exhaust pipe 136 from being further inserted into the flat open side end 120 of the base Tee connector 100.

In another embodiment of the present invention, the flat open side end 120 is provided with two or more pins 140 (see FIG. 5) that are attached to the deformed portion 119 of the sheet metal at a position close to the flat open side end 120, extending radially inwardly for engagement with corresponding bayonet slots on the open end of an exhaust pipe when the open end of the exhaust pipe is received in the flat open side end 120 of the base Tee connector 100. The bayonet slots are similar to those illustrated in FIG. 1 and will not therefore be further described herein. When the pins 140 are provided, the inner periphery 120 is optional.

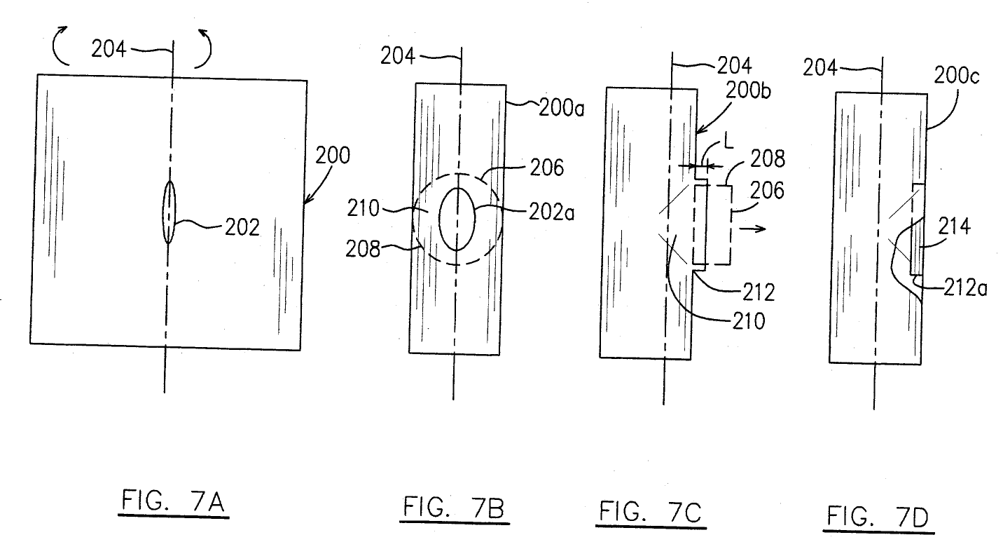

FIGS. 7A-7D illustrate a manufacturing process. A piece of sheet metal 200 has a predetermined dimension and a slot 202 is cut in the middle of the piece of sheet metal 200 as shown in FIG. 7A. The piece of sheet metal 200 is then bent around an axis 204 that is parallel to the slot 202, thereby forming a cylindrical pipe 200a with opening 202a. The opening 202a generally has the same axial length as the slot 202, which is predetermined to be smaller than the diameter of the internal diameter of the flat open side end of the base Tee connector which is to be formed. The width of the opening 202a is however, wider than the width of the slot 202 due to the deformation of the piece of sheet metal 200.

A die tool 206 being sized to equal the inner diameter of the flat open side end to be formed, is placed in the cylindrical pipe 200a. The die tool 206 is then aligned with the opening 202a and forcibly pulled out in a direction perpendicular to axis 204, through the opening 202a. A portion 210 of sheet metal around the opening 202a is pressed by a cylindrical surface 208 to cause permanent deformation thereof, thereby forming a horizontal section 212 of a base Tee connector 200b when the die tool 206 is removed through the newly formed horizontal section 212. The newly formed horizontal section 212 may not at this point define a flat open side end, depending on the size and shape of the original slot 202. If the horizontal section 212 is trimmed to form a flat open side end as shown in FIG. 7C, the base Tee connector 200b will have a conventional Tee configuration as shown in FIG. 3.

In order to manufacture a base Tee connector according to the present invention, the projecting portion of the horizontal section 212 of the base Tee connector 200b is cut along a plane substantially tangential to the vertical cylindrical section of the base Tee connector 200b. The tangential location of the plane is more clearly illustrated in FIG. 5. The base Tee connector that is manufactured in this manner does not have the inner periphery 224 of the flat open side end 120 as shown in FIG. 5. In order to manufacture a base Tee connector 100 of FIG. 5, the projecting portion of the horizontal section 212 of the base Tee connector 200b is trimmed to have a flat open side end, as conventional base Tee connector 20 of FIG. 3. However, the projecting length indicated by letter L should be determined in accordance with the width of the inner periphery 124 of the flat open side end 120 of the base Tee connector 100 of FIG. 5. The narrow projecting portion of the horizontal section 212 of the base Tee connector 200b is first bent radially and inwardly and is then pushed, for example by a die tool similar to the die tool 206 but having a slightly smaller diameter, inwardly in a direction perpendicular to the tangential plane 122 illustrated in FIG. 5. Thus, by following the above mentioned steps, a base Tee connector of the present invention is manufactured, similar to the base Tee connector 200c illustrated in FIG. 7D.

The base Tee connector 200c, however, is provided with internal threads 214 which are formed on the internal periphery 212a in accordance with another embodiment of the present invention. In FIG. 7D, a portion of the sheet metal of the base Tee connector 200c is cut away to illustrate the threads 214 on the internal periphery which is adapted for threadedly engaging corresponding external threads on an open end of an exhaust pipe when the exhaust pipe is connected to the base Tee connector 200c.

In FIG. 5 the diameter of the flat open side end 120 is preferably equal to the diameter of the cylindrical pipe 102 and can be smaller, depending on the size of the exhaust pipe to be connected thereto. However, the diameter of the flat open side end 120 cannot be greater than the diameter of the cylindrical pipe 102.

FIG. 9 illustrates a base Tee connector 300 in accordance with a further embodiment of the present invention. The base Tee connector 300 includes two or more engaging tabs 302 (four tabs are provided in this embodiment although only two are shown). The engaging tabs 302 are attached to the external surface of the deformed portion 234 of the base Tee connector 300 for engagement with corresponding tab receiving elements such as hooks or slotted brackets attached to the external surface of an exhaust pipe at its open end. A variety of locking devices can be used with the base Tee connector of the present invention, either at the inner side or outer side of the flat open side ends. These locking devices are well known in the art and will therefore not be further described herein.

The base Tee connector of the present invention can be used for connecting a substantially horizontal pipe to a substantially vertical pipe such as for use in venting piping, and is not only limited to connection of an exhaust pipe to a chimney liner.

Modifications and improvements to the above-described embodiments of the present invention may become apparent to those skilled in the art. The foregoing description is intended to be exemplary rather than limiting. The scope of the invention is therefore intended to be limited solely by the scope of the appended claims.

I/we claim:

1. A base Tee connector for connecting a substantially horizontal pipe to a substantially vertical pipe, comprising:
a main hollow body including a substantially cylindrical wall, the substantially cylindrical wall defining an open top end of the connector adapted for connection of the substantially vertical pipe;
an open side end adapted for connection of the substantially horizontal pipe; and
the open side end defining a plane substantially tangential with respect to the substantially cylindrical wall of the main hollow body.

2. A base Tee connector as claimed in claim 1 wherein the main hollow body comprises a bottom opening.

3. A base Tee connector as claimed in claim 1 comprising means for securing the connection of the substantially horizontal pipe with the open side end of the connector.

4. A base Tee connector as claimed in claim 1 wherein the open side end comprises an annular lip extending inwardly in a direction perpendicular to the plane defined by the open side end, and thereby defining an inner periphery of the open side end.

5. A base Tee connector as claimed in claim 4 wherein the inner periphery of the open side end comprises an inner edge spaced apart from the plane defined by the open side end, the inner edge being adapted for engaging clips attached to the substantially horizontal pipe when an open end of the substantially horizontal pipe is received in the open side end of the connector.

6. A base Tee connector as claimed in claim 4 wherein the inner periphery of the open side end comprises a thread formed thereon for engaging a complementary thread on the substantially horizontal pipe when an open end of the substantially horizontal pipe is received in the open side end of the connector.

7. A base Tee connector as claimed in claim 3 wherein the securing means are positioned within the open side end of the connector.

8. A base Tee connector as claimed in claim 3 wherein the securing means are positioned on an exterior of the open side end of the connector.

9. A base Tee connector for connecting an exhaust pipe to a chimney liner, comprising: a section of cylindrical pipe made of sheet metal including an open top end adapted for connection with the chimney liner and an open bottom end, a portion of the sheet metal of the cylindrical pipe being deformed and thereby defining a flat open side end adapted for connection with the exhaust pipe, the flat open side end being disposed substantially parallel to and at a distance from a central longitudinal axis of the cylindrical pipe, the distance being substantially equal to a radius of the cylindrical pipe.

10. A base Tee connector as claimed in claim 9 wherein the flat open side end comprises an inwardly folded annular lip extending in a direction substantially perpendicular to the flat open side end.

11. A base Tee connector as claimed in claim 9 further comprising a cover for detachably closing the open bottom end.

12. A base Tee connector as claimed in claim 9 wherein the flat open side end defines a round opening having a diameter substantially equal to a diameter of the cylindrical pipe.

13. A base Tee connector as claimed in claim 9 further comprising means at the flat open side end thereof for releaseably securing the exhaust pipe when connected with the flat open side end.
